(19) United States
(12) Patent Application Publication
(10) Pub. No.: US 2011/0260552 A1
(43) Pub. Date: Oct. 27, 2011

(54) METHOD AND DEVICE FOR CONTROLLING THE ADJUSTMENT OF A SWITCHING STATE OF AN ELECTRIC SWITCHING SYSTEM IN THE FIELD OF GUIDED VEHICLES

(75) Inventor: Pierre Capdevila, Chatillon (FR)

(73) Assignee: SIEMENS S.A.S., St. Denis (FR)

(21) Appl. No.: 13/140,180

(22) PCT Filed: Dec. 16, 2008
(86) PCT No.: PCT/FR2008/001754

§ 371 Date: Jul. 19, 2011

(51) Int. Cl. H01H 9/16

(52) U.S. Cl. 307/112

(57) ABSTRACT

A method and a device dynamically control the secure adjustment of a binary switching state of at least one electric switching system built into an automatically functioning apparatus used in the field of guided vehicles, the switching system driving at least one actuator by a driving circuit. The device includes: a control module controlling the state of the electric switching system, and a reading device capable of reading the switching state of the electric switching system and of transmitting a control signal related to the read switching state to a monitoring module. The device is characterized in that the reading device is provided downstream from the electric switching system and is coupled to the driving circuit of the actuator, thereby providing the automatically functioning apparatus with enhanced reliability and maintainability.

Method and device for controlling the adjustment of a switching state of an electric switching system in the field of guided vehicles.

This invention regards a method and device for dynamically controlling the secure, i.e. safer, adjustment of a binary switching state, for example open or closed, of at least one electric switching system, according to the preambles to Claims 1 and 10.

In particular, the invention concerns the increased reliability and maintainability of electric switching systems built into an automatically functioning apparatus used in the field of guided vehicles (for example, railways), said electric switching system driving at least one actuator by means of a driving circuit delivering a digital output relating to the respectively open or closed switching state of the switching system.

The term “guided vehicle” refers in particular to public transport methods such as buses, trolleybuses, trams, metros, trains or train units, etc., for which the security aspect is very important. This security aspect is in particular linked to the correct operation of automatically functioning apparatuses inside and outside the vehicle. Examples of internal and external automatically functioning apparatuses include, respectively, the automatic closing of train doors and the points control in a metro system. Within this context, it is important that the operator of the vehicle be able to rapidly detect and repair any faults in the automatically functioning apparatus, not just to guarantee the safety of passengers in the vehicle, but also to maintain the availability of the vehicle and/or the movement of other vehicles (for example, movement of other vehicles hindered by a technical failure of the automatically functioning apparatus).

The switching system can sometimes break down as a result of a lack of reliability, natural wear, or an overload. Two fault modes are generally observed:
cut-off: the switching system is in an open state although it has been commanded to a closed state,
stuck: the switching system is in a closed state although it has been commanded to an open state.

In order to detect and repair these faults rapidly, it is particularly necessary to be able to read the open or closed state of an electric switching system. It is therefore necessary to check that the state commanded has actually been executed by the switching system in order to prevent any divergence between the state commanded and the state actually executed.

In this regard, a method enabling the adjustment of an electromechanical relay driving an actuator to be checked is known to the person skilled in the art. The electromechanical relay is a specific electric switching system, comprising mainly an electromagnet providing a mechanical contact through movement of a mobile part known as the contactor, an upstream electrical circuit and a downstream electrical circuit. The contactor is fitted with a main contact and an auxiliary contact, the main contact being used to control the actuator and the auxiliary contact to reread the state of the relay. This method includes the following steps:
the transmission of a state command from the contactor, relay open (upstream electrical circuit isolated from the downstream electrical circuit) or closed (upstream and downstream circuits in contact), said transmission being sent from a command module,
the execution of said state command by the electromechanical relay,
transmission of a control signal to a control module after reading of the state, open or closed, of the electromechanical relay, said control signal being related to the state read and the reading being effected using the auxiliary contact, mechanically attached to the main contact.

Unfortunately, this method applies only to the specific case of electromechanical relays and cannot be used, for example, in a static relay, in which an auxiliary contact is not possible. Furthermore, a major disadvantage of this method is that it only works if the auxiliary contact is in the same state as the main contact, which is not always the case with an ordinary relay, in particular in the event of a sticking fault, and it therefore requires the use of special relays having connected, non-overlapping contacts, one of which is used to drive the actuator, while the other is looped back to the control module. Moreover, even with special relays, the method does not reliably cover sticking faults. Finally, this method makes it possible, by comparison of the state read with the state commanded, to detect faults up to the electromagnet, but it only very rarely makes it possible to detect a fault of the contactor, hence a lack of reliability.

One objective of this invention is to propose a method for reliably and dynamically controlling the secure adjustment of a binary switching state, open or closed, of at least one electric switching system built into an automatically functioning apparatus used in the field of guided vehicles and driving at least one actuator, in order to secure the switching system and improve the reliability and maintainability of the automatically functioning apparatus.

Another objective of the invention is to guarantee the small size of the automatically functioning apparatus, and a low probability of error of the reading of said state regardless of the electrical design of the driving of the actuator (electric switching system and/or driving circuit and/or electrical circuit inside the actuator), the method under no circumstances disturbing said driving of the actuator, and conversely, operation of the actuator never altering the reading of the switching state.

In order to implement the method according to the invention, a device for dynamically controlling the secure adjustment of a binary switching state of at least one electric switching system built into an automatically functioning apparatus of a guided vehicle and driving at least one actuator will be proposed.

For this purpose, a device and a method are proposed by the content of Claims 1 and 10.

On the basis of a method for dynamically controlling the secure adjustment of a binary switching state (open or closed) of at least one electric switching system built into an automatically functioning apparatus used in the field of guided vehicles, said switching system driving at least one actuator by means of a driving circuit supplying electrical power to the actuator by means of at least one digital output (corresponding to the binary switching state), said method comprising the following steps:
transmission of a state command from a command module to the electric switching system,
execution of said state command by the electric switching system,
transmission of a control signal to the control module after reading the switching state of the electric switching system, said control signal relating to the switching state read,
   the method according to the invention is characterized in that said reading is effected downstream of the switching system from a signal taken from the driving circuit, said signal indicating whether the driving circuit is in active mode (i.e. closed), or inactive mode (i.e. open).

In particular, the method according to the invention is characterized in that the reading is effected by connecting the driving circuit to at least one transformer acting as an isolation component. The transformer may advantageously be miniaturized so that it occupies a small space in the automatically functioning apparatus and moreover, it guarantees good electrical isolation ensuring that the operation of the actuator is not disturbed and that the electrical characteristics of the digital output are not altered.

Also, the transformer may advantageously provide electrical power to enable a reading by opto-isolator on the driving circuit. In particular, opto-isolation only occurs when the switching system is closed, thereby enabling the transmission to the control module of a control signal correlated to the closed state of the switching system. Conversely, if the switching system is open, opto-isolation does not take place, enabling the transmission of a reading signal correlated to the open state of the switching system. Opto-isolation thus guarantees the transmission of two different control signals depending on whether the switching system is open or closed.

The binary characteristic of the state of the switching system is thereby re-written in the control signal via opto-isolation.

The method according to the invention is also characterized in that the reading is effected by current measurement or impedance measurement via the transformer. Advantageously, the reading and the electrical isolation are effected by a single component, the transformer, saving not only space, but also money.

The method according to the invention is also characterized in particular in that said control module is able to compare the state commanded with the state read and to flag any divergence between the state read and the state commanded, said divergence being characteristic of a probable fault. Moreover, said divergence may advantageously be communicated in real-time using a warning signal to a maintenance station having a maintenance team standing by to work on the site of said divergence to correct it. Said warning signal is specific to the control module where it originates, thereby enabling the rapid and easy location of the site of the divergence.

In particular, the method according to the invention is characterized in that at least one of said transmissions (transmission of a command or transmission of a control signal) is effected using a remote link. The underlying advantage is a remote check of the electric switching system and/or a remote transmission of the switching state of the switching system. This may be for example the remote checking by a train of the correct points switching of the track, but also, a remote transmission of information concerning the opening/closing of doors, the transmission of said information being linkable for example to a vehicle-starting condition. In this context, the remote commanding of the command and control modules makes it possible to exchange information concerning the switching state of the switching system. In particular, the switching state of the switching system may be commanded remotely via the command module. In this case, the command module receives, by means of remote communication, information or an order concerning a state to be commanded, then it sends a state command, related to the order or information received, to the switching system. Finally, the state actually executed by the electric switching system can be determined remotely via the control module which sends information relating to the switching state read over a remote link.

On the basis of a device for dynamically controlling the secure adjustment of a binary switching state of at least one electric switching system built into an automatically functioning apparatus used in the field of guided vehicles, said switching system driving at least one actuator by means of a driving circuit supplying electrical power to the actuator by means of at least one digital output (corresponding to the binary switching state), said device comprising:
a command module commanding the state of the electric switching system,
a reading device able to read the switching state of the electric switching system, and to send to a control module a control signal relating to the switching state read,
   the device according to the invention is characterized in that said reading device is placed downstream of the electric switching system and is connected to the driving circuit of the actuator.

In particular, the device according to the invention is characterized in that the reading device includes at least one transformer acting as an isolating component connected to the driving circuit. Indeed, the transformer enables a connection with no galvanic contacts between the electronics in the reading device and the electronics in the driving circuit of the actuator. Furthermore, as the transformer can advantageously be miniaturized, the space taken up by the reading device in the automatically functioning apparatus is small.

Furthermore, the device according to the invention is characterized in that the reading device includes an opto-isolator powered by said transformer. The opto-isolator makes it possible to send a different signal depending on whether the switching system is in an closed or open state. The reading device will therefore send a control signal correlated to the binary characteristic of the state of the switching system. Another advantage of using an opto-isolator is being able to galvanically isolate the electronics related to the reading device from the electronics related to the driving circuit.

In this context, the transformer may advantageously be used to send a signal adjusted to the reading of the switching state using a current measurement or an impedance measurement. In this case, the transformer is not only used as a galvanic isolator, but also as a reader of the switching state, occupying, in its dual role as isolating component and reading component, a small space in the automatically functioning apparatus.

Equally, the device according to the invention is characterized in that the control module includes a state comparator comparing the state commanded with the state read that is able to flag and send information relating to a divergence between the state commanded and the state read. This comparison between the state commanded and the state actually executed (i.e. the state read) makes it possible to simply and rapidly check whether the switching system is in the state commanded in order to detect a failure of the switching system corresponding to a divergence between the state read and the state commanded. Advantageously, if the control module includes an intelligent circuit, such as, for example and non-exhaustively, a microprocessor, an FPGA component (Field-Programmable Gate Array), or an ASIC circuit (Application-Specific Integrated Circuit), it is then possible to multiplex the signals outputted by several (at least two) reading devices and to have a single comparator, in order to save space and occupy a small space by reducing the number of comparators. Furthermore, the control module is able to flag said divergence to ensure that maintenance work on the automatically functioning apparatus can be performed easily and quickly by locating the fault by identifying the faulty switching system. In particular, the command module and/or the control module include a device that is able to remotely send and receive data relating to the switching state of the switching system. Thus, the switching state can be commanded remotely using the command module, then the state actually executed, i.e. the state read, can be sent remotely to a control position. For example, a train can remotely command the points of a track, then receive feedback confirming or invalidating the points switch commanded. Advantageously, in the event of invalidation, a new track can be chosen in time to avoid the problematic points switch and thereby guarantee the correct movement of the vehicle.

Examples of embodiments and applications are provided using the following figures:

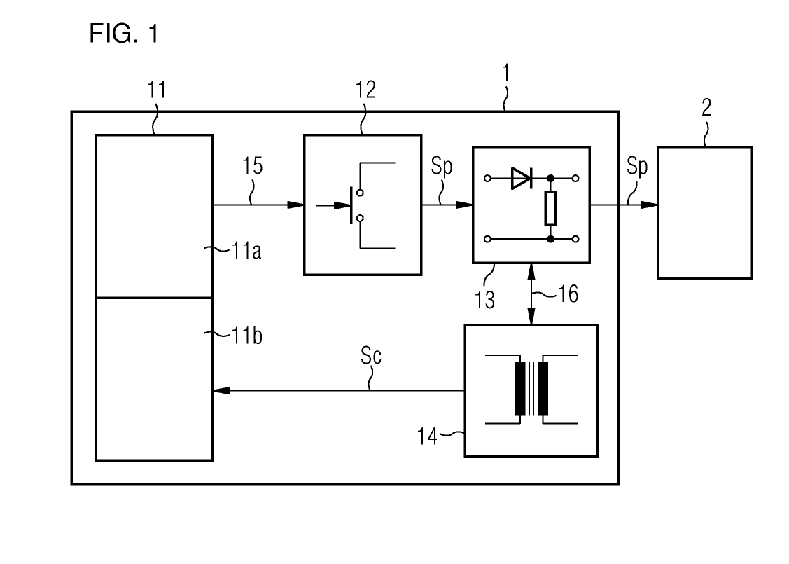

FIG. 1 Sample embodiment of a dynamic control device for the secure adjustment of a binary switching state,

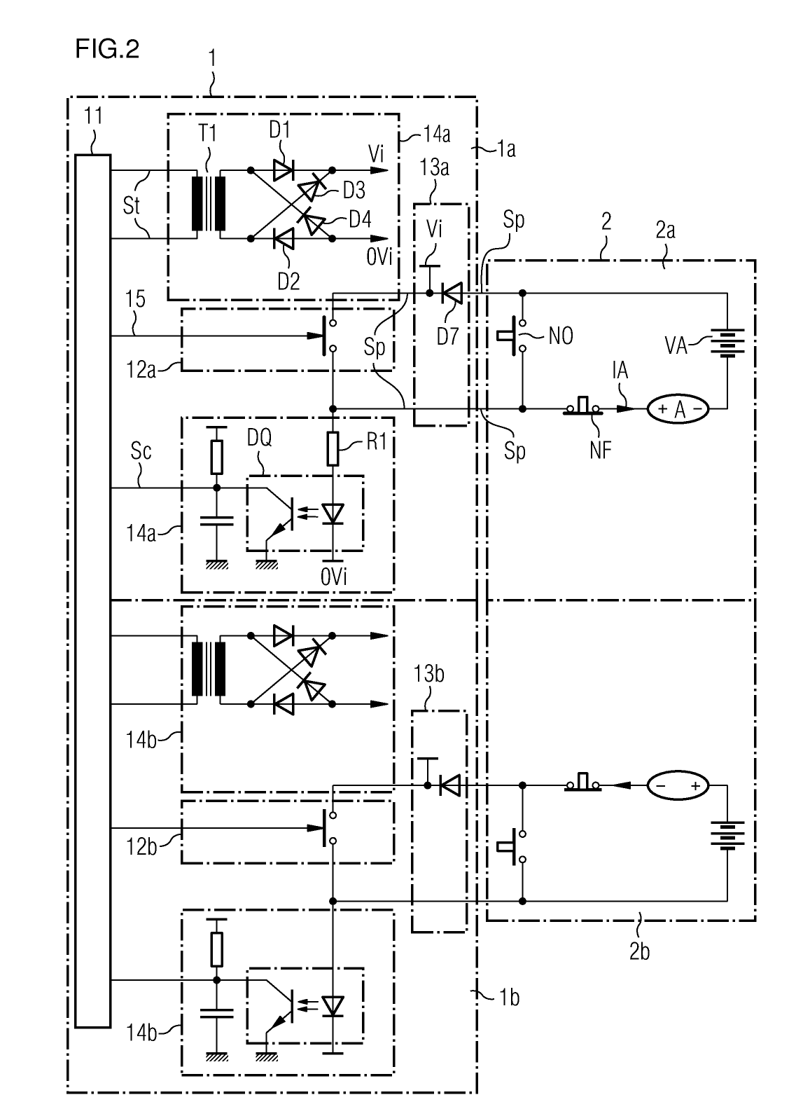

FIG. 2 Sample embodiment of a dynamic control device for the secure adjustment of a binary switching state by reading said state using an opto-isolator,

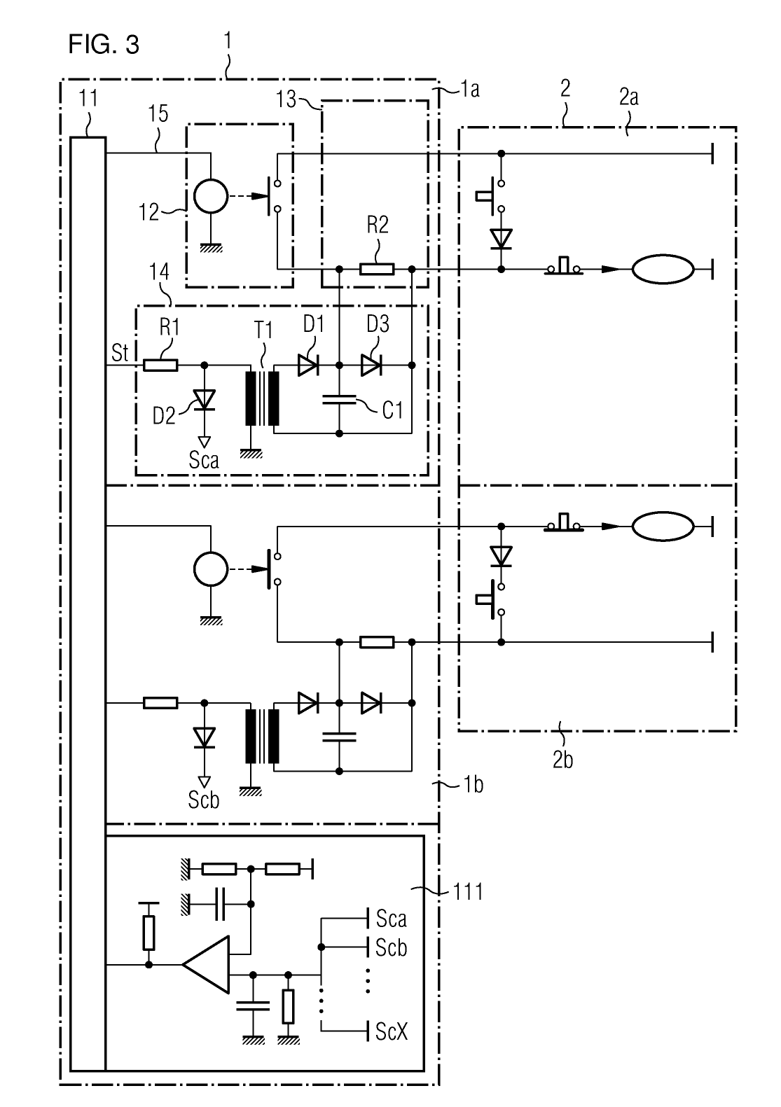

FIG. 3 Sample embodiment of a dynamic control device for the secure adjustment of a binary switching state by reading said state using a current measurement,

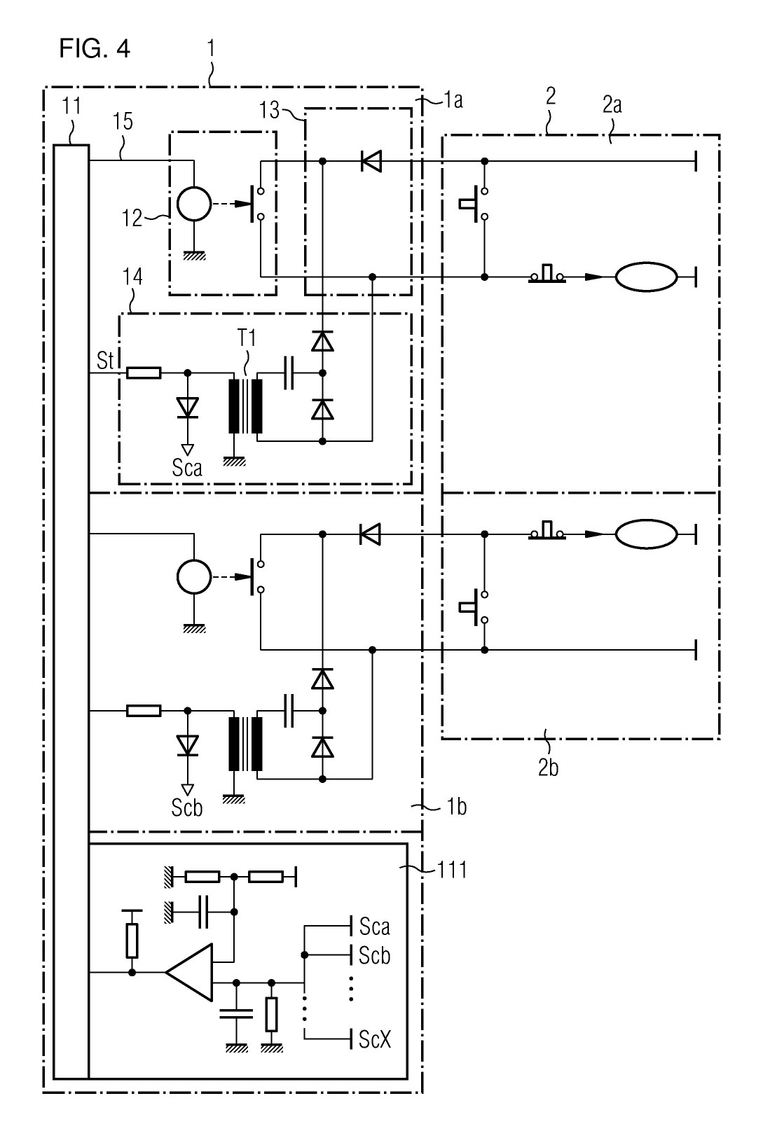

FIG. 4 Sample embodiment of a dynamic control device for the secure adjustment of a binary switching state by reading said state using an impedance measurement.

By way of example, FIG. 1 shows a device for dynamically controlling the secure adjustment of a binary switching state of at least one electric switching system (12) built into an automatically functioning apparatus (1), said switching system (12) driving at least one actuator (2) by means of a driving circuit (13). The device including:
a command module (11a) commanding the state of the electric switching system, in particular by means of a state command (15),
a reading device (14) able to read the switching state of the electric switching system (12), and to send to a control module (11b) a control signal (Sc) relating to the switching state read,
   is characterized in that the reading device (14) is placed downstream of the electric switching system (12) and is connected to the driving circuit (13) of the actuator (2). In particular, said connection enabling the reading (16) may include at least one transformer used as an isolating component and one opto-isolator used as a reading component, or also, in another variant, said transformer may act as an isolating and reading component, thereby performing two functions. Moreover, a drive signal (Sp) is sent by the electric switching system (12) to the actuator (2) via said driving circuit (13), said driving circuit being able to configure the drive signal (Sp) as a function of the (electrical) characteristics of the actuator (2). Also, the characteristics of the command module (11a) and of the control module (11b) may be grouped in a single secure adjustment module (11) that is able to control and command the adjustment of the switching system and the actuator, in particular, by means of remote links.

FIGS. 2 to 4 are detailed embodiments according to FIG. 1. They show respectively a reading of the switching state via an opto-isolator, via a current measurement and via an impedance measurement.

In particular, FIG. 2 shows an actuator (2a) driven via a driving circuit (13a) by an electric switching system (12a) that receives a state command (15) from a secure adjustment module (11). A control signal (Sc), containing information on the state actually executed, is sent to the secure adjustment module (11) by a reading device (14a) that takes a reading by opto-isolator (DQ) of the state of the switching system. The reading device (14a) is itself configured and controlled by a command signal (St) sent from the secure adjustment module (11), in particular, the command signal (ST) powers a transformer (T1) of the reading device (14). The opto-isolator (DQ) includes in particular at least one light-emitting diode and one phototransistor. The reading device (14a) includes the transformer (T1) connected to a diode bridge (D1, D2, D3, D4, D7) supplying voltage (Vi, 0Vi) via a resistor (R1) to the light-emitting diode of the opto-isolator (DQ). When the switching system (12a) is closed, the light-emitting diode of the opto-isolator (DQ) is powered by the isolated voltage (Vi) via the resistor (R1): the phototransistor of the opto-isolator (DQ) is conductive. On the other hand, if the switching system (12a) is open, the current in the light-emitting diode of the opto-isolator (DQ) is zero: the phototransistor of the opto-isolator (DQ) is blocked. This binary state (conductive, blocked) of the phototransistor makes it possible to send to the secure adjustment module a control signal (Sc) characterized by two different states (i.e. corresponding to the conductive or blocked state of the phototransistor) making it possible to check the switching state of the switching system (12a). Furthermore, the automatically functioning apparatus (1) can drive several actuators (2) using a multiplexing technique: a family (1a) formed by a switching system (12a), a driving circuit (13a) and a reading device (14a) drives a first actuator (2a), and another family (1b), formed by a switching system (12b), a driving circuit (13b) and a reading device (14b) drives a second actuator (2b). If n is the number of actuators, then n families will each drive at least one actuator. Also, a redundancy technique in which several families, i.e. two or more families, can command one single, or at least one single, actuator advantageously makes it possible to secure the switching system. Although the number of families is not restricted in quantity, they are nonetheless commanded and controlled by a single secure adjustment module (11). Specifically, to effect this multiplexing, the command signals (St) and control signals (Sc) of each family are linked to each other such that the command signals (St) take it in turns to command/power the transformers (T1) of the reading devices. Thus, for n actuators, the secure adjustment module (11) generates in a first period a first command signal (St) that generates a signal on the transformer T1 of the reading device (14a) of the family (1a) and in response, the secure adjustment module (11) receives a first control signal (Sc) from the reading device (14a). Then, in a second period, the secure module (11) generates a second command signal (St) that generates a signal on the transformer T1 of the reading device (14b) of the family (1b) and in response, the secure adjustment module (11) receives a second control signal (Sc) from the reading device (14b). The actuators are thus driven and the relays controlled iteratively one after the other, families (14a) to (14n) continuously or intermittently. Finally, another advantage of this device is that the handling of contacts that are normally open (NO) or normally closed (NF) outside the automatically functioning apparatus (1), but that are part for example of the actuators (2), do not cause errors in the reading of the state of the switching system.

Another sample embodiment according to FIG. 1 is given by FIG. 3, characterized in that the state of the electric switching system (12) is read by a current measurement via the transformer (T1) belonging to the reading device (14). The reading device (14) of FIG. 3 is firstly checked by the secure adjustment module via a control/command signal (St) and, secondly, unlike FIG. 2, it includes resistors (R1, R2), diodes (D1, D2, D3), a capacitor (C1) and a transformer (T1) making it possible to read the switching state of the switching system (12) using a current measurement on the driving circuit (13). In particular, the current measurement has different values depending on whether the state of the electric switching system is open or closed. This difference in the value of the current measurements makes it possible to send a control signal (Sca) correlated to the open or closed state of the switching system (12). This control signal (Sca) is sent by the reading device (14) to a state comparator (111) that is part of the secure adjustment module (11). The state comparator (111) compares the control signal (Sca) with a reference signal, said comparison making it possible to determine whether the state commanded corresponds to the state read. If there is any divergence between the state commanded and the state read, the secure adjustment module is able to send (remotely) a warning signal to a maintenance team enabling the fault in the automatically functioning apparatus to be located and defined. Finally, similarly to FIG. 2, the automatically functioning apparatus (1) can drive in particular several actuators (2) using a multiplexing technique: a family (1a) formed by a switching system (12), a driving circuit (13) and a reading device (14) driving a first actuator (2a) is connected to the secure adjustment module (11) in parallel with a second family (1b) identical to the family (1a) driving a second actuator (2a). While the family (1a) enables the transmission of a control signal (Sca) to the comparator (111), the family (1b) enables the transmission of a second control signal (Scb) to the same comparator (111). As the number of families is not limited, the comparator (111) makes it possible to compare each control signal (Sca, Scb, . . . , ScX) with said reference signal, and to thus determine the state actually executed by the electric switching system. In particular, the comparator (111) can compare the control signals iteratively (one after the other) using an iterative state command sent to the different electric switching systems by the secure adjustment module. Also, the state comparator is able to process the comparison of the different control signals with a reference signal simultaneously, advantageously enabling the faster reading of the switching state of the electric switching systems.

Another sample embodiment according to FIG. 1 is given by FIG. 4. FIG. 4 is identical to FIG. 3 and therefore has the same characteristics, with the difference that the reading device (14) enables a reading by measuring the impedance variation in the driving circuit (13) located downstream of the electric switching system (12) to which it is connected. The advantage of this embodiment over the previous one is that the device does not give false alarms if the current in the actuator is not as expected on account of an event outside the automatically functioning apparatus, such as, for example and non-exhaustively, an action on the pushbuttons, a fault in an actuator, a short circuit or a cut-off in the wiring of the train.

In summary, the method and the device according to the invention provide several advantages over existing methods or devices in that:
they improve the reliability of operational control of the automatically functioning apparatus and enable a rapid, localized and secure detection of faults,
they secure the switching system by making it possible for example to iteratively or simultaneously check a redundancy of the automatically functioning apparatus, such as, for example, the securing of identical families (1a, 1b, . . . ) commanded and controlled by the same secure adjustment module (11),
they improve the maintainability of the automatically functioning apparatus by making it possible to send precise fault information in real-time to the maintenance team,
they make it possible to detect faults regardless of the electric switching system (electromechanical relay or static relay for example), and in particular, they make it possible to detect sticking or cut-out faults downstream of the electromagnet of an electromechanical relay,
they make it possible for the automatically functioning apparatus to occupy a small space,
they make it possible to read the switching state regardless of the electrical design of the switching system, of the driving circuit and of the actuator, and without altering their electrical characteristics or correct operation.

1-16. (canceled)

17. A method for dynamically controlling a secure adjustment of a binary switching state of at least one electric switching system built into an automatically functioning apparatus related to the field of guided vehicles, the electric switching system driving at least one actuator by means of a driving circuit, the method comprises the steps of:
transmitting a state command from a command module to the electric switching system;
executing the state command by means of the electric switching system;
transmitting a control signal to a control module after reading a switching state of the electric switching system, the control signal relating to the switching state read; and
effecting the reading downstream of the electric switching system from a further signal taken from a driving circuit, the further signal indicating whether the driving circuit is active or inactive.

18. The method according to claim 17, which further comprises effecting the reading by connecting the driving circuit to at least one transformer acting as an isolation component.

19. The method according to claim 18, which further comprises effecting the reading with an opto-isolator powered by the transformer.

20. The method according to claim 18, which further comprises effecting the reading by a current measurement via the transformer.

21. The method according to claim 18, which further comprises effecting the reading by an impedance measurement via the transformer.

22. The method according to claim 17, wherein the control module is able to compare a command state with the switching state read and to flag any divergence between the switching state read and the state command.

23. The method according to claim 17, which further comprises effecting at least one of the transmitting steps via a remote link.

24. The method according to claim 17, which further comprises commanding the command module remotely and receiving information concerning a switching state commanded by means of a remote link.

25. The method according to claim 17, which further comprises commanding the control module remotely and sending information relating to the switching state read by means of a remote link.

26. A device for dynamically controlling a secure adjustment of a binary switching state of at least one electric switching system built into an automatically functioning apparatus related to the field of guided vehicles, the switching system driving at least one actuator by means of a driving circuit, the device comprising:
a command module commanding a state of the electric switching system;
a control module; and
a reading device able to read a switching state of the electric switching system, and to send to said control module a control signal relating to the switching state read, said reading device disposed downstream of the electric switching system and is connected to the driving circuit of the actuator.

27. The device according to claim 26, wherein said reading device includes at least one transformer acting as an isolating component connected to the driving circuit.

28. The device according to claim 27, wherein said reading device includes an opto-isolator powered by said transformer.

29. The device according to claim 27, wherein said transformer supplies a signal adjusted to the switching state read by current measurement.

30. The device according to claim 27, wherein said transformer supplies a signal adjusted to the switching state read by impedance measurement.

31. The device according to claim 26, wherein said control module has a state comparator able to flag and send information relating to a divergence between a state commanded and a state read.

32. The device according to claim 26, wherein at least one of said command module or said control module include a device that is able to remotely send and receive data relating to the switching state of the electric switching system.
